(19) United States
(12) Patent Application Publication
(10) Pub. No.: US 2025/0324201 A1
(43) Pub. Date: Oct. 16, 2025

(54) Speaker and Microphone with Utg Diaphragm

(71) Applicant: Glass Acoustic Innovations Co., Ltd., New Taipei (TW)

(72) Inventors: Yao-Sheng CHOU, New Taipei (TW); Yi-Feng WEI, New Taipei (TW); Kwun-Kit CHAN, New Taipei (TW)

(21) Appl. No.: 18/969,194

(22) Filed: Dec. 4, 2024

(30) Foreign Application Priority Data
Apr. 11, 2024 (TW) 113113496

(51) Int. Cl. H04R 7/10; H04R 7/12; H04R 7/18; H04R 9/02; H04R 9/06; H04R 9/08

(52) U.S. Cl. CPC H04R 7/10; H04R 7/125; H04R 7/18; H04R 9/025; H04R 9/06; H04R 9/08; H04R 2307/025; H04R 2307/027; H04R 2400/11; H04R 2499/11; H04R 2499/15

(57) ABSTRACT

A diaphragm for a speaker includes a lower surface area, a central area formed on said lower surface area, an upper surface area formed on said central area. The upper surface area, the central area and the lower surface area includes homogeneous amorphous materials. The diaphragm includes internal stress changing with a depth from the surface to the center of the diaphragm.

### BACKGROUND

### 1. Technical Field

The present invention relates to a speaker, and more particularly, a speaker diaphragm.

### 2. Related Art

A speaker converts electronic signals into sounds. Since the 19th century, speaker development has lasted for more than a hundred years. Generally, audio output devices such as speakers and headphones have a diaphragm configurated there inside. When signals are output, the diaphragm will vibrate in responsive to the signal to propagate sound. In order to enable the diaphragm to effectively vibrate with sound signals, it is better to employ materials with high rigidity and appropriate damping properties for the diaphragm.

Speakers typically include a magnet component, and a sound coil is located nearby the magnet component. The diaphragm is mechanically attached to the sound coil. In most cases, other supporting components such as a diaphragm surround (or suspension), a frame are also included in the speaker. The interaction between the magnetic field and the current will cause the diaphragm vibration according to the Fleming's law. Since the sound propagation, absorption (attenuation) and reflection are frequency-dependent and are nonlinear. The sound is radiated from the entire diaphragm in a very complex pattern. Therefore, the material, shape and other characteristics of the diaphragm greatly affect the sound quality of the speaker.

With the rapid development of electronic and information technology, more and more speakers are widely used in various electronic products in people daily life. People not only concern about their miniaturization and multi-function, but also require the quality of the sound. As the core component of the speaker, the diaphragm's design directly affects the characteristics of the acoustic device.

### SUMMARY

The object of the present invention is to provide a UTG diaphragm speaker, which includes a magnetic component for generating magnetic field. A diaphragm of the speaker includes UTG glass, the thickness of the UTG diaphragm is about 0.01 to 0.1 mm. A voice coil is configurated corresponding to the UTG diaphragm, and cooperates with the magnetic component to generate driving force to promote the vibration of the UTG diaphragm. The UTG diaphragm speakers also include a suspension that connects the diaphragm to the outer frame.

The method of forming the UTG includes fusion/pull-down processes which involve the non-contact processes to stably achieve a glass with a thickness of 30 microns or even less. There is no contact with the outside during the whole process, so the surface of the glass plate is smooth and clean, and there is no need for grinding and polishing. To successfully pull down ultra-thin glass, the viscosity of the raw material and the pulling speed must be accurately controlled. Uneven thickness, holes, or even fragments must be avoided during the glass pulling down process. The UTG diaphragm may include, but not limited to, aluminosilicate, borosilicate, aluminoborosilicate, soda-lime, or other suitable glass. In some embodiments, the UTG layers are formed from the mother glasses into the UTG layer 130 through cutting and thinning processes.

In another embodiment, the diaphragm at least includes an upper layer or a lower layer with a thickness greater than or equal to 1 micron and less than or equal to 15 microns. The upper or lower layer is made of aluminum, nickel, copper, diamond, resin or polymer. The UTG diaphragm is a planar UTG diaphragm or a three-dimensional UTG diaphragm. The UTG diaphragm includes the following shapes, for example, planar rectangular, planar circular, planar oval, planar oblong, 3D concave circle (cone), 3D convex circle (dome), cup-shape, bowl-shape, dome-shape, pyramid-shape. The UTG speaker diaphragms are suitable for the applications of audio, headphones, mobile phones, laptops, tablets, and TVs.

In yet another embodiment, the UTG diaphragm microphone includes a UTG glass diaphragm which has a thickness of 0.01 to 0.1 mm. The diaphragm at least includes an upper layer or a lower layer, the thickness is greater than or equal to 1 micron and less than or equal to 15 microns. The upper layer or lower layer is aluminum, nickel, copper, diamond, resin or polymer.

### BRIEF DESCRIPTION OF THE DRAWINGS

FIG. 1A is a cross-sectional view of the diaphragm of the present invention.

FIG. 2A-2D show cross-sectional views of the diaphragm of the present invention.

FIG. 2E shows the cross-sectional view and the top view of the earphone diaphragm of the present invention.

FIG. 3A is the cross-sectional view of the speaker of the present invention.

FIG. 3B is the cross-sectional view of the speaker of another embodiment.

FIG. 3C is the cross-sectional view of the yet another embodiment of the present invention.

FIG. 4 shows the UTG diaphragm microphone of the present invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

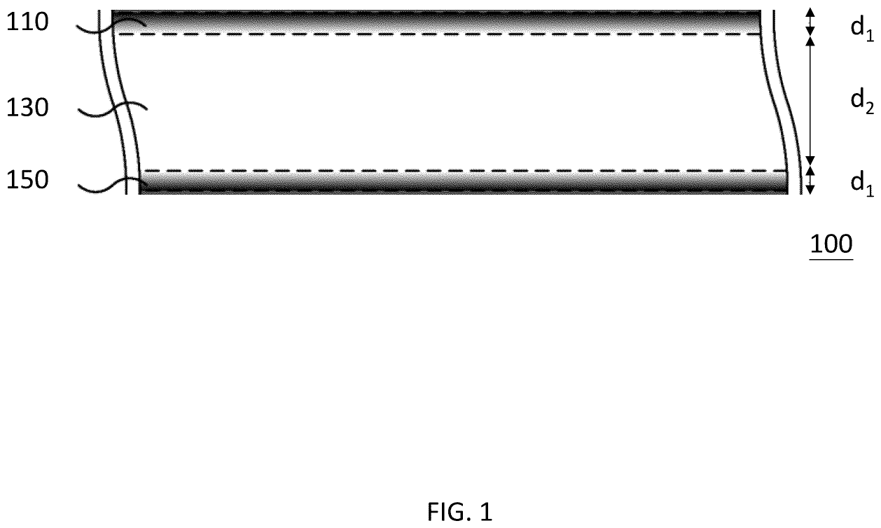

The energy typically decays when the sound propagates from one medium to another medium, especially, the sound velocity or acoustic-impedance in the two mediums is different, even if the two mediums have the same density. Appropriate energy-loss is beneficial to the quality of the sound. With the development of employing acoustic devices in various products, people require small but distortion-free speaker. In order to further apply the ultra-thin diaphragm to mini-speakers and microphones, for example such as earphones or mobile phone microphones, please refer to FIG. 1, the thickness of the UTG diaphragm 100 should preferably be controlled in the range of 0.01 to 0.1 mm.

The present invention discloses the speaker with the UTG diaphragm structure 100. As shown in FIG. 1, the material of the UTG diaphragm 100 includes homogeneous glass. Generally, the glass is hard and fragile, but when the thickness of the glass is ≤100 microns, it has softness and bendability properties, and it can be provided as the diaphragms. The UTG glass is 0.01 to 0.1 mm thick and is produced using a strengthening process to enhance its flexibility and durability. The UTG glass production method includes fusion/pull-down processes which may stably achieve a thickness of 30 microns or even less, other pull-down method can be used as well. During the entire process, it will not come into contact with the outside, therefore, the surface of the glass plate is smooth and clean, and there is no need for grinding and polishing. To successfully pull down ultra-thin glass, the viscosity of the raw material and the pulling speed must be accurately controlled. Uneven thickness, holes, or even fragments must be avoided during the glass pulling process. The rollers that transport the glass, the pressure control, and the surface flatness are also key factors. After the UTG glass sheet is produced, in one embodiment, it can be cut during the manufacturing process, and the total thickness is less than 30 microns. The UTG treatment of the present invention includes the following steps: immerse the UTG material to be treated in an HF solution, followed by performing etching; the concentration of the HF solution is 1 to 4 mol/L; the etching time is 8 to 30 minutes; followed by cleaning the glass to remove residual acid on the surface, and pre-heat the glass to 350˜400° C.; the following steps include immersing the preheated UTG in the strengthening liquid; followed by annealing the UTG. In another example, CPI (transparent polyimide) has the flexibility of plastic, the UTG material can be laminated with the transparent CPI material. The UTG, an optical glue layer, the CPI, and a hardened layer are stacked in sequence, using the UTG as the bottom layer to support the softer CPI on the upper layer.

FIG. 1 shows the UTG diaphragm 100. The UTG layer 130 of the UTG diaphragm 100 may include, but not limited to, aluminosilicate, borosilicate, aluminum borosilicate, soda-lime or other suitable glass. In some embodiments, the UTG layer 130 is formed from the mother glass into the UTG layer 130 through cutting processes, and an anti-shattering coating process may also be applied.

In some optional embodiments, the thickness d2 of the UTG layer 130 is preferably about 10 microns to 50 microns. According to embodiments of the present invention, a part or all of the upper surface or lower surface of the UTG diaphragm structure 100 can be coated, grown, sputtered with aluminum, nickel, copper, diamond, resin or polymer films to improve the diaphragm damping. In another optional embodiment, after the UTG sheet is produced, ultra-thin diamond, aluminum, nickel, and copper films are grown during the manufacturing process, which can not only modulate damping, but also enhance toughness, and the thickness is less than 50 microns. In one embodiment, the ultra-thin films, such as diamond films, is grown on at least one side of the UTG layer 130. Each layer is formed with a thickness less than 15 μm. The thickness d1 of the upper layer 110 is preferably about 1-15 microns, and the thickness d1 of the lower layer 150 is also about 1-15 microns. The ultra-thin diamond/glass film employs a panel process to grow the diamond-grade UTG. It does not require additional chemical strengthening processes and the robust is excellent. The surface is as soft as paper but has diamond-level hardness. The most important thing is that it is not easy to break.

The UTG diaphragm 100 of the present invention may be applied for the speakers of consumer productors including but not limited to, audio devices, headphones, mobile phones, laptops, tablets, televisions, etc. The UTG acts as the microphone diaphragm in the mobile phone. According to another embodiment of the present invention, the method of manufacturing the UTG diaphragm 100 includes fusion/pull-down processes. Based on the above structure, the present invention does not require chemical treatment to strengthen the toughness and does not require to etch for thinning the thickness. In addition, the diaphragm does not need to be processed with gradient manners. The characteristics of the diaphragm are illustrated by the following embodiments of the diaphragm.

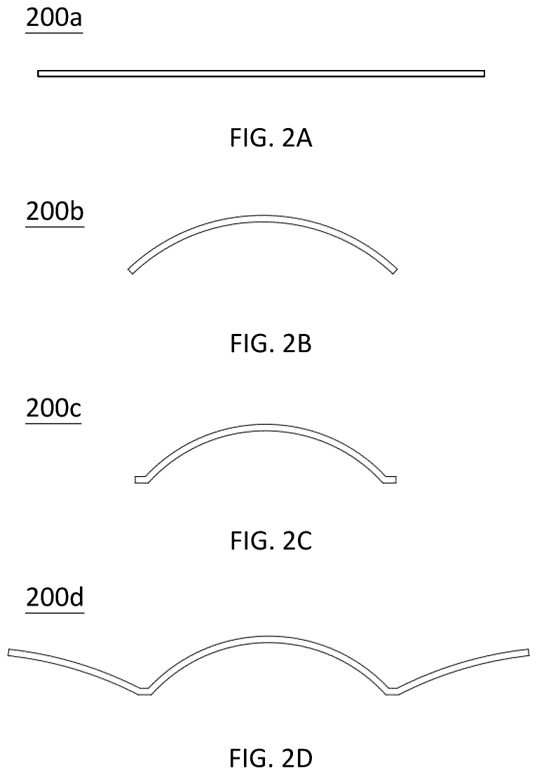

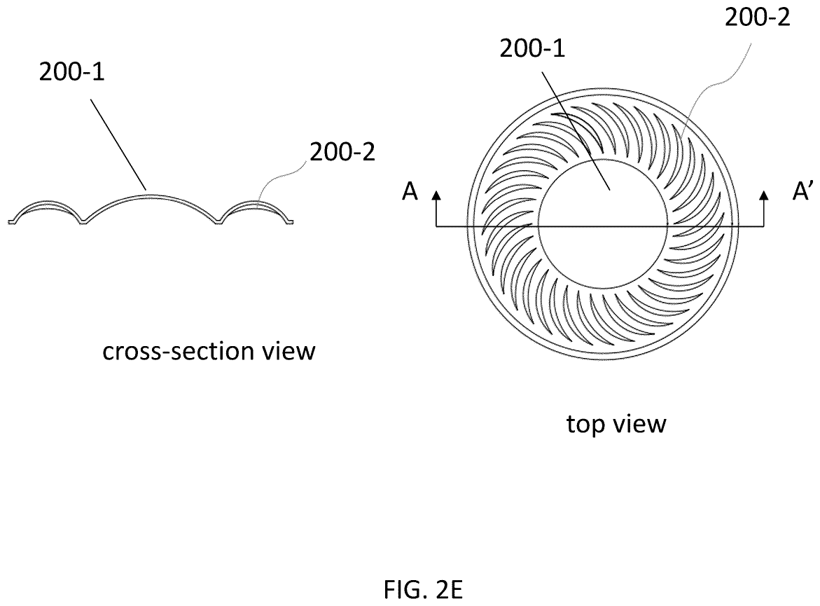

Please refer to FIGS. 2A-2D, which are schematic cross-sectional views according to embodiments of the present invention. The features shown in FIG. 1 are introduced. The cross-sectional of the diaphragm can be various shapes. For example: a planar UTG diaphragm 200a as shown in FIG. 2A, a dome-shape UTG diaphragm 200b as shown in FIG. 2B, a dome-shape having wing structure UTG diaphragm (200c, 200d) as shown in FIGS. 2C-2D. Therefore, the shape made by using the above structure can have the following shapes when viewed from the top views: circular, rectangular, elliptical (Oval/Elliptical), obround (Obround) and other shapes, and the three-dimensional shapes include cup-shape, bowl-shape, and dome-shape, pyramid shape, etc.

FIG. 2E shows the top view and the cross-sectional view of the UTG diaphragm 200e which is applied for headphones. The UTG diaphragm 200e includes a central dome area 200-1 and its suspension 200-2 which surrounds the central dome area 200-1. The annular folds of the suspension 200-2 can also be formed with different shape grooves. In one embodiment, the plurality of grooves is formed in a rotating radial shape. The annular area, that is, the suspension should be soft and flexible enough to undergo substantial deformation. The design of the dome area 200-1 is used to improve the rigidity of the diaphragm to reduce the high-frequency distortion caused by split vibration. The peripheral wrinkle area of the diaphragm requires a certain degree of flexibility and elasticity, the radial folds structures are employed to block the expansion of sound waves.

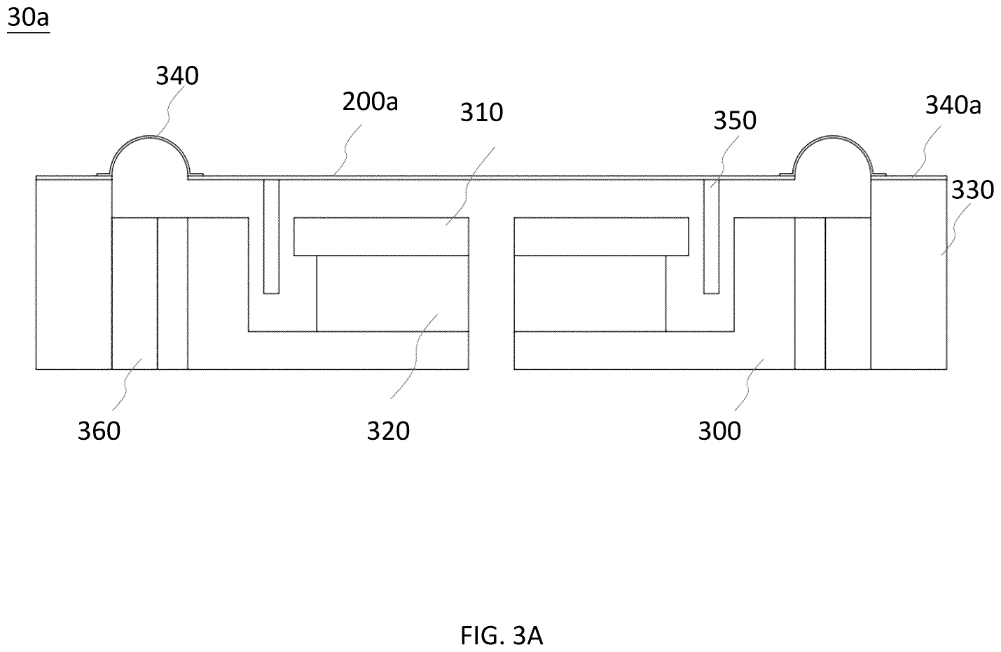

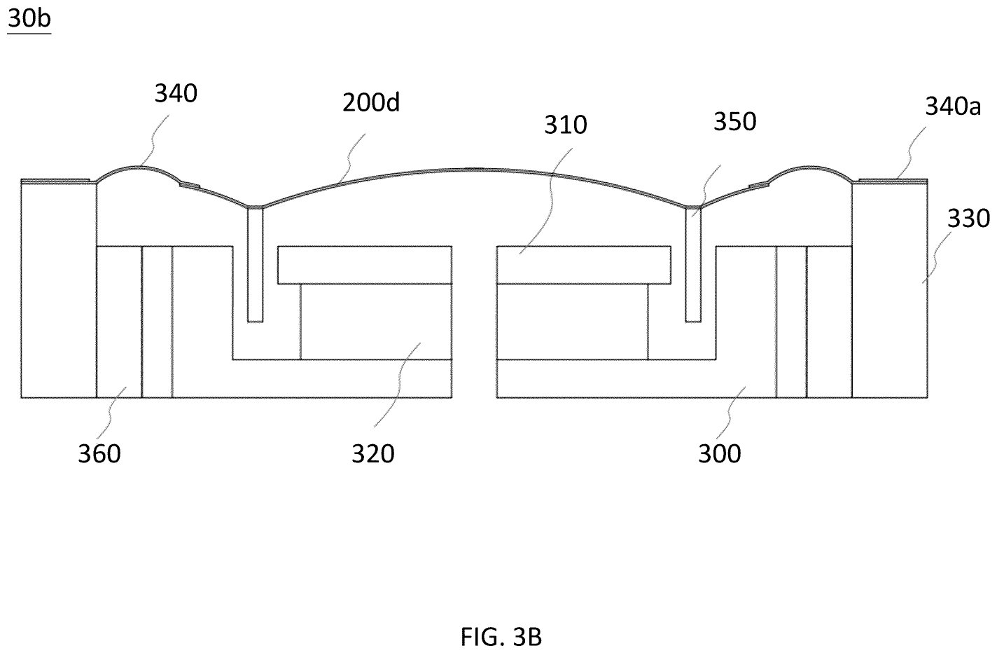

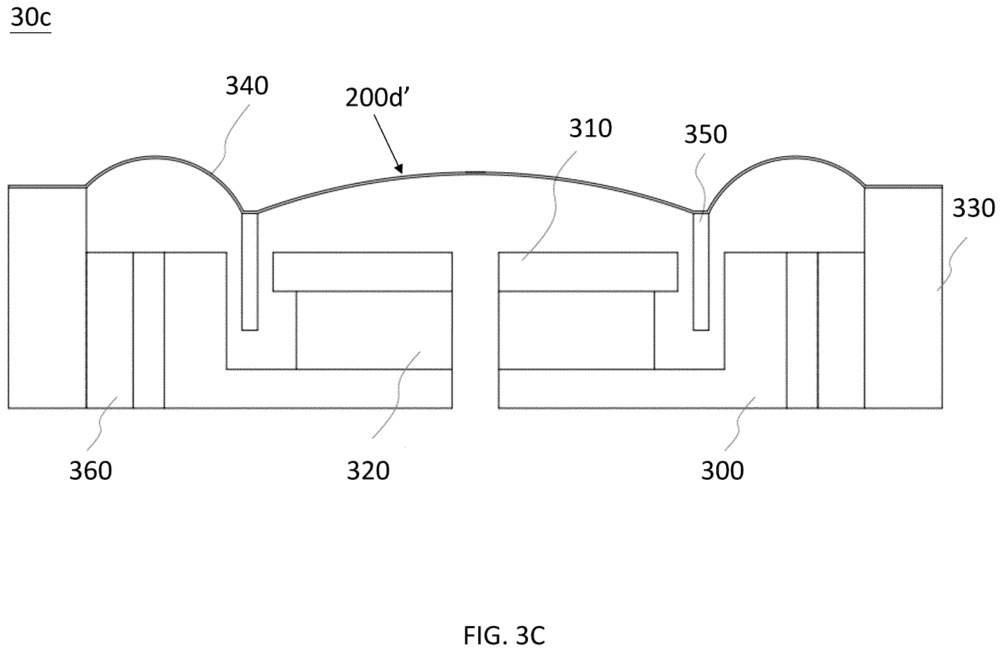

Referring to FIG. 3A, which is a schematic diagram of a speaker according to an embodiment of the present invention. The speaker 30a may use the planar UTG diaphragm 200a shown in FIG. 2A. FIG. 3A shows the relationship among the planar diaphragm 200a and other components in the speaker 30a. As shown in FIG. 3A, the speaker 30a mainly includes a U iron 300 as a back plate, a washer 310, a permanent magnet 320, a frame 330, and a suspension (surround) 340, a surrounding ring 340a, a voice-coil 350, and a UTG diaphragm 200a. The UTG diaphragm 200a covers the permanent magnet 320. The UTG diaphragm 200a does not contact the stationary components in the speaker 30a, such as the U iron 300, the washer 310, the permanent magnet 320 and the frame 330, but only contacts the movable components in the speaker, such as the suspension 340, there is an air gap 360 between the U iron 300 and the frame 330.

According to an embodiment of the present invention, the permanent magnet 320 is an annular magnet disposed inside the voice coil 350. The washer 310 has a ring shape similar to the permanent magnet 320. The permanent magnet 320 is disposed in the U iron 300 which is U-shape and has a through hole at the bottom. Similarly, the permanent magnet 320 and the washer 310 both have the hollow part that is aligned with the through hole of the U iron 300. This configuration reduces the weight of the speaker assembly and provides a vent for airflow at the rear of the speaker. According to the embodiment of the present invention, the planar diaphragm 200a is coupled to the frame 330 through the suspension 340 and the suspension ring 340a, wherein the suspension 340 is an elastic film that can vibrate together with the planar diaphragm 200a, and the suspension ring 340a is used to fix the suspension 340.

FIG. 3B is a partial structural schematic diagram of a speaker according to another embodiment of the present invention. The speaker 30b uses the UTG diaphragm 200d with a dome-shape as shown in FIG. 2D. The dome has a wing structure. FIG. 3B shows the connection among the diaphragm 200d and other components in the speaker 30b. As shown in FIG. 3B, the speaker 30b mainly includes the U iron 300, the washer 310, the permanent magnet 320, the frame 330, the suspension 340, the suspension ring 340a, the voice coil 350, and the dome-shape wing structure UTG diaphragm 200d. The UTG diaphragm 200d with the dome-shape/wing structure completely covers the permanent magnet 320. The UTG diaphragm 200d will not touch the stationary components in the speaker 30a, such as the U iron 300 and the washer 310. The permanent magnet 320 and the frame 330 only contact the movable components in the speaker, such as the suspension 340 and the voice coil 350. The air gap 360 is formed between the U iron 300 and the frame 330.

According to an embodiment of the present invention, the dome-shaped/wing structure UTG diaphragm 200d is coupled with the frame 330 through the suspension 340 and the suspension ring 340a. The suspension 340 is an elastic film which may vibrate together with the UTG diaphragm 200d, and the suspension ring 340a fixes the suspension 340.

Similarly, FIG. 3C is a diagram of a speaker according to yet another embodiment of the present invention. The speaker 30c uses a UTG diaphragm 200d′ with a dome-shape having wing structure as shown in FIG. 2D, in which the UTG diaphragm 200d′ and the suspension 340 are integrally formed. FIG. 3C shows the connection among the dome-shaped UTG diaphragm 200d′ and other components in the speaker 30b. As shown in FIG. 3C, the all of the elements such as the U iron 300, the washer 310, the permanent magnet 320, the frame 330, the suspension 340, the voice coil 350 are almost similar with the aforementioned embodiment in FIG. 3B, excepts the shape of the diaphragm. The UTG diaphragm 200d′ with the dome-shaped/wing structure. The UTG diaphragm 200d′ completely covers the permanent magnet 320. The U iron 300 is disposed inside the frame 330 and has the air gap 360 between the U iron 300 and the frame 330. According to an embodiment of the present invention, the UTG diaphragm 200d′ is coupled to the frame 330 through its suspension 340, the suspension 340 is elastic.

Please refer to FIGS. 3A-3C, the speaker (30a, 30b, 30c) includes the UTG diaphragm (200a, 200d, 200d′), the suspension 340, the voice coil 350 and the frame 330 as a support member. In addition to the vibration components, the speakers (30a, 30b, 30c) also include the U iron 300, the washer 310, the permanent magnet 320 and the frame 330. The U iron 300 is used to accommodate the permanent magnet 320 arranged in the hollow of the voice coil 350. The permanent magnet 320 is fixed to the U iron 300 through the washer 310. The voice coil 350 is coupled to the UTG diaphragm (200a, 200d, 200d′), and AC current interacts with the magnetic field to generate the driving force, thereby vibrating the UTG diaphragm (200a, 200d, 200d′).

The present invention may act as a microphone diaphragm. The microphones receive sound signals through the diaphragm. The front side of the microphone diaphragm receives sound pressure, and the back side is coupled to a coil, and the coil is wrapped around a magnet. When the front of the diaphragm receives sound pressure, the vibration of the diaphragm will cause the coil to move and induce electricity with the magnet. As the sound pressure increases, the degree of movement of the diaphragm also increases, and the microphone circuit then amplifies the generated current. Compared to condenser microphones, condensers require additional power for the microphone to operate.

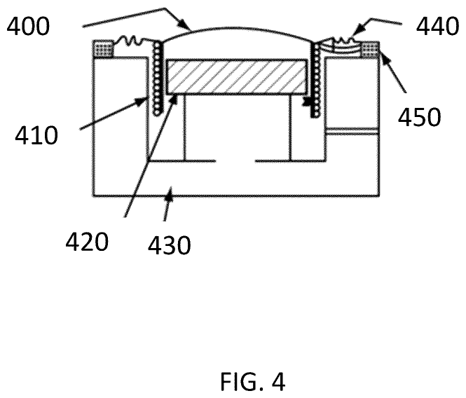

Referring to FIG. 4, the microphone assembly includes a UTG diaphragm 400, which receives the sound wave vibrations, and convert the kinetic energy into electronic signals. The microphone usually includes an upper plate 420 and a magnetic yoke 430.0 In addition, the assembly also includes a suspension 440 and a terminal head 450. When a sound wave enters the microphone, the UTG diaphragm 400 is subjected to the pressure of the sound wave and vibrates. According to Faraday's law, the coil 410 coupled to the UTG diaphragm 400 generates an induced current in the magnetic field. Ribbon microphones are also a type of dynamic microphone. The main difference from dynamic microphones is that they use a very thin metal sheet instead of the diaphragm and coil. The present invention can be applied to various microphones mentioned above.

The shape of the UTG diaphragm 400 of the present invention can be various shapes, such as circular, rectangular, elliptical, oblong and other shapes. The thickness of the UTG diaphragm 400 of the microphone is preferably controlled in a range of 0.01 to 0.1 mm. The material selected for the UTG diaphragm 400 is homogeneous glass. As mentioned above, the UTG glass production method includes fusion/pull down processing. The method uses the non-contact slit/pull-down procedures. Microphones with UTG diaphragm 400 can be used in mobile phones, tablets, computers, laptops, game consoles, local telephones, public telephones, vehicles, karaoke, etc.

The shape of the diaphragm includes the following shapes, for example, planar rectangular, planar circular, planar oval, planar oblong, 3D concave circle (cone), 3D convex circle (dome), cup-shape, bowl-shape, dome-shape, pyramid-shape and other shapes.

While various embodiments of the present invention have been described above, it should be understood that they have been presented by a way of example and not limitation. Numerous modifications and variations within the scope of the invention are possible. The present invention should only be defined in accordance with the following claims and their equivalents.

What is claimed is:

1. A UTG diaphragm speaker, comprising:
a magnetic component for generating magnetic field;
a voice coil configured corresponding to a diaphragm and said magnetic component to vibrate said diaphragm; and
wherein a thickness of said diaphragm is between 0.01-0.1 mm.

2. The speaker of claim 1, further comprising a suspension connected between said diaphragm with a frame.

3. The speaker of claim 1, wherein said diaphragm at least includes an upper layer or a lower layer.

4. The speaker of claim 3, wherein a thickness of said upper layer is greater than or equal to 1 micron and less than or equal to 15 microns.

5. The speaker of claim 3, wherein a thickness of said lower layer is greater than or equal to 1 micron and less than or equal to 15 microns.

6. The speaker of claim 3, wherein said upper layer includes aluminum, nickel, copper, diamond, resin or polymer.

7. The speaker of claim 3, wherein said lower layer includes aluminum, nickel, copper, diamond, resin or polymer.

8. The speaker of claim 1, wherein said diaphragm includes planar rectangular, planar circular, planar oval, or planar oblong shape.

9. The speaker of claim 1, wherein said diaphragm includes cone, dome, cup, bowl, or pyramid shape.

10. The speaker of claim 1, wherein said diaphragm is employed for headphones, mobile phones, laptops, tablets, and televisions.

11. The speaker of claim 1, wherein said diaphragm is employed for microphone.

12. A UTG diaphragm speaker, comprising:
a magnetic component for generating magnetic field;
a voice coil configured corresponding to a diaphragm and said magnetic component to vibrate said diaphragm; and
wherein said diaphragm at least includes an upper layer or a lower layer, wherein a thickness of said diaphragm is between 0.01-0.1 mm.

13. The speaker of claim 12, further comprising a suspension connected between said diaphragm with a frame.

14. The speaker of claim 12, wherein a thickness of said upper layer is greater than or equal to 1 micron and less than or equal to 15 microns.

15. The speaker of claim 12, wherein a thickness of said lower layer is greater than or equal to 1 micron and less than or equal to 15 microns.

16. The speaker of claim 12, wherein said upper layer includes aluminum, nickel, copper, diamond, resin or polymer.

17. The speaker of claim 12, wherein said lower layer includes aluminum, nickel, copper, diamond, resin or polymer.

18. The speaker of claim 12, wherein said diaphragm includes planar rectangular, planar circular, planar oval, or planar oblong shape.

19. The speaker of claim 12, wherein said diaphragm includes cone, dome, cup, bowl, or pyramid shape.

20. The speaker of claim 12, wherein said diaphragm is employed for headphones, mobile phones, laptops, tablets, and televisions.
